(19) United States
(12) Patent Application Publication
(10) Pub. No.: US 2014/0100814 A1
(43) Pub. Date: Apr. 10, 2014

(54) MEASURING DEVICE, MEASURING METHOD, AND COMPUTER READABLE MEDIUM

(71) Applicant: KABUSHIKI KAISHA TOSHIBA, Tokyo (JP)

(72) Inventors: Yuta ITOH, Kanagawa (JP); Akihito Seki, Kanagawa (JP); Kenichi Shimoyama, Tokyo (JP); Satoshi Ito, Kanagawa (JP); Masaki Yamazaki, Tokyo (JP)

(73) Assignee: KABUSHIKI KAISHA TOSHIBA, Tokyo (JP)

(21) Appl. No.: 13/800,103

(22) Filed: Mar. 13, 2013

(30) Foreign Application Priority Data
Jul. 2, 2012 (JP) 2012-148658

(51) Int. Cl. G01B 11/24

(52) U.S. Cl. CPC G01B 11/24
USPC 702/152

(57) ABSTRACT

According to an embodiment, a measuring device includes a generating unit, an updating unit, and a calculating unit. The generating unit is configured to generate first position and orientation of an observing unit for observing a space containing a target object, an error model indicating a theoretical precision of observation, and three-dimensional shape data of the target object. The updating unit is configured to update space information that indicates a probability of the presence of the target object at each coordinate within the space, using the first position and the three-dimensional shape data. The calculating unit is configured to calculate a measurement quality increment for second position and orientation of a search area within the space using the error model and the space information, and set third position and orientation for which the calculated measurement quality increment satisfies a predetermined condition as new position and orientation, respectively.

### CROSS-REFERENCE TO RELATED APPLICATION

This application is based upon and claims the benefit of priority from Japanese Patent Application No. 2012-148658, filed on Jul. 2, 2012; the entire contents of which are incorporated herein by reference.

### FIELD

An embodiment described herein relates generally to a measuring device, a measuring method, and a computer program product.

### BACKGROUND

While performing three-dimensional measurement, three-dimensional shape data of a target object for measurement is generated by observing that object. In order to perform a highly accurate measurement in which no portion of the target objet for measurement is left unmeasured, the selection of the position and the orientation to be used in observing the object assumes importance. For example, a technology is known in which the position and the orientation to be used in observing an object are calculated by taking into account whether or not other objects are present on the periphery.

### BRIEF DESCRIPTION OF THE DRAWINGS

FIG. 1 is a diagram illustrating an example of a measuring device according to an embodiment;

FIG. 2 is a diagram for explaining an example of odds according to the embodiment;

FIG. 3 is a diagram for explaining an exemplary method of updating an observation flag according to the embodiment;

FIG. 4 is a diagram illustrating an example of a display according to the embodiment; and

FIG. 5 is a flowchart for explaining an exemplary sequence of operations performed in the measuring device according to the embodiment.

### DETAILED DESCRIPTION

According to an embodiment, a measuring device includes a generating unit, an updating unit, and a calculating unit. The generating unit is configured to generate a first position of an observing unit for observing a space containing a target object, a first orientation of the observing unit, an error model indicating a theoretical precision of observation performed by the observing unit, and three-dimensional shape data of the target object that has been observed by the observing unit. The updating unit is configured to update space information that indicates a probability of the presence of the target object at each coordinate within the space, using the first position and the three-dimensional shape data. The calculating unit is configured to calculate a measurement quality increment for a second position and a second orientation of a search area within the space using the error model and to the space information, and set a third position and a third orientation for which the calculated measurement quality increment satisfies a predetermined condition as a new position and a new orientation of the observing unit, respectively.

An exemplary embodiment is described below in detail with reference to the accompanying drawings.

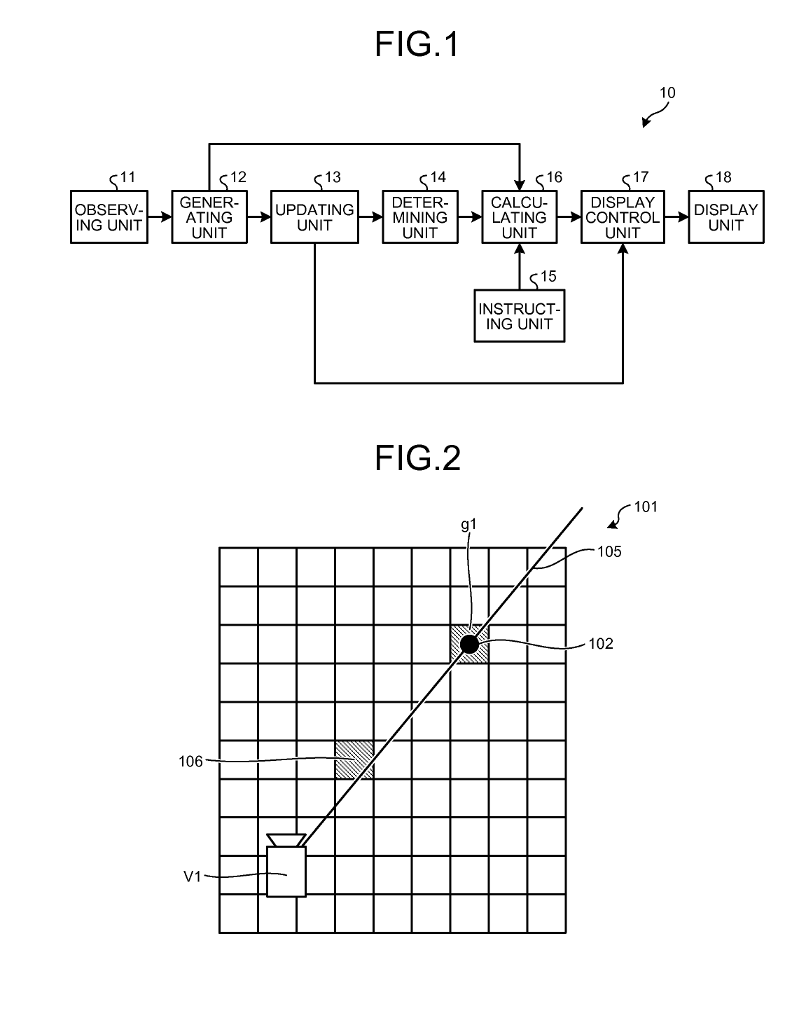

FIG. 1 is a configuration diagram illustrating an example of a measuring device 10 according to the embodiment. As illustrated in FIG. 1, the measuring device 10 includes an observing unit 11, a generating unit 12, an updating unit 13, a determining unit 14, an instructing unit 15, a calculating unit 16, a display control unit 17, and a display unit 18.

The observing unit 11 obtains observation data by observing a space that contains a target object for measurement. The observation data points to, for example, the three-dimensional coordinates of the target object for measurement. Herein, the observing unit 11 can be implemented using, for example, an optical camera or a laser range finder (LRF). Alternatively, the observing unit 11 can be implemented using a stereo camera, or using a sensor such as an omnidirectional camera or a Time-of-Flight camera.

The generating unit 12, the updating unit 13, the determining unit 14, the instructing unit 15, the calculating unit 16, and the display control unit 17 can be implemented by executing computer programs in a processing unit such as a central processing unit (CPU). That is, the generating unit 12, the updating unit 13, the determining unit 14, the instructing unit 15, the calculating unit 16, and the display control unit 17 can be implemented using software.

The generating unit 12 generates the position (as an example, a first position) and the orientation (as an example, a first orientation) of the observing unit 11; generates three-dimensional shape data of the target object for measurement; and generates an error model that indicates the theoretical precision of the observation performed by the observing unit 11.

The position and the orientation of the observing unit 11 are expressed as (R, T), which is a set of rotation R and translation T in the world coordinate system. The three-dimensional shape data of the target object for measurement is expressed as RX+T, which is obtained by the observing unit 11 as observation data by converting the three-dimensional coordinate X of the target object for measurement in the coordinate system of the observing unit 11 into the world coordinate system using the set (R, T) of rotation R and translation T. Thus, the three-dimensional shape data of the target object for measurement is expressed as the three-dimensional coordinates in the world coordinate system.

If the observing unit 11 is an optical camera; the generating unit 12 makes use of, for example, simultaneous localization and mapping (SLAM) and makes use of the observation data of the observing unit 11, and generates the position and the orientation of the observing unit 11 as well as generates the three-dimensional shape data of the target object for measurement. Alternatively, if the observing unit 11 is an LRF; the generating unit 12 refers to, for example, the method disclosed in the literature “Using laser range data for 3D SLAM in outdoor environments” by D. Cole and P. Newman in Proc. of the IEEE Int. Conf. on Robotics & Automation (ICRA), 2006, pp. 1556-1563 and makes use of the observation data of the observing unit 11, and generates the position and the orientation of the observing unit 11 as well as generates the three-dimensional shape data of the target object for measurement.

Herein, although the detailed explanation is not given, even when the observing unit 11 is either a stereo camera or a sensor such as an omnidirectional camera or a Time-of-Flight camera; the generating unit 12 makes use of a method suitable to the observing unit 11 and makes use of the observation data of the observing unit 11, and generates the position and the orientation of the observing unit 11 as well as generates the three-dimensional shape data of the target object for measurement.

In the coordinate system of the observing unit 11, when the coordinate of the measurement result is \tilde{x}; the error model of the observing unit 11 points to the conditional probability of having the true coordinate become x. The error model of the observing unit 11 is expressed as given below in Expression (1).

Pr(x|\tilde{x}) (1)

In a monocular stereo in which the observing unit 11 is an optical camera and three-dimensional measurement is performed by capturing images while moving the optical camera, consider a case when two sets of position and orientation are provided, when the pixel sizes of optical elements is provided, and when internal parameters of the optical camera are provided. In that case, the generating unit 12 generates the error model of the observing unit 11 by referring to, for example, the method disclosed in the literature “Stochastic analysis of stereo quantization error” by J. J. Rodriguez and J. K. Aggarwal in IEEE Transactions on Pattern Analysis and Machine Intelligence, 12:467-470, 1990. Alternatively, when the observing unit 11 is an LRF and when a known error precision is provided from a data sheet or the like; the generating unit 12 generates the error model of the observing unit 11 by referring to, for example, the method disclosed in the literature “Characterization of the compact Hokuyo URG-04LX 2D laser range scanner” by L. Kneip, F. Tache, G. Caprari, and R. Siegwart in Proc. of the IEEE Int. Conf. on Robotics & Automation (ICRA), 2009. Meanwhile, while generating the error model of the observing unit 11, the method to be implemented by the generating unit 12 is not limited to the methods disclosed in the literature mentioned above.

When a monocular stereo is used, the positions and the orientations used during the past observations performed by the observing unit 11 are stored as observation history in a memory unit (not illustrated) by the generating unit 12. In that case, in order to generate the error model of the observing unit 11 at an arbitrary provided position and an arbitrary provided orientation, the generating unit 12 selects a past position closest to the provided position and a past orientation closest to the provided orientation from the observation history and then implements one of the methods mentioned above. Herein, the closeness of the provided position and the provided orientation to a past position and a past orientation in the observation history is defined by a mixture in a predetermined ratio of the difference in positions, the difference in orientations, the position norms, and the orientation norms. Herein, the observation history can include all sets of positions and orientations of the observing unit 11 starting from the first observation to the current observation, or can include an appropriate selection of the sets of positions and orientations of the observing unit 11.

In the case of using a monocular stereo with an optical camera, the generating unit 12 can output the observation history to the calculating unit 16, and the calculating unit 16 can be configured to generate the error model of the observing unit 11.

The updating unit 13 refers to the position of the observing unit 11 generated by the generating unit 12 and to the three-dimensional shape data generated by the generating unit 12, and accordingly updates space information that represents the probability of the presence of the target object for measurement at each coordinate within the space. Alternatively, in order to update the space information, the updating unit 13 can also make use of the error model of the observing unit 11 generated by the generating unit 12. Herein, the space information further indicates whether or not each coordinate within the space has been observed by the observing unit 11 as well as indicates whether or not each coordinate within the space is on the outside of the target object for measurement.

In the embodiment, with respect to the grid in each of exclusive division areas that are three-dimensional grid-like areas of a predetermined size obtained by uniformly dividing the three-dimensional space in the world coordinate system (more specifically, with respect to the center of gravity that is the representative point of the grid in each division area); the space information is assumed to contain the odds that represent the probability of the presence of the target object for measurement in that particular grid, an observation flag that indicates whether that particular grid is already observed or is yet to be observed, and an external flag that indicates whether or not that particular grid is on the outside of the target object for measurement. In the embodiment, if the observation flag is set to “1”, it is assumed that the grid is already observed. In contrast, if the observation flag is set to “0”, it is assumed that the grid is yet to be observed. Similarly, if the external flag is set to “1”, it is assumed that the grid is on the outside of the target object for measurement. In contrast, if the external flag is set to “0”, it is assumed that the grid is not on the outside of the target object for measurement. Herein, the external flag is used in distinguishing the grid belonging to the inside of the object from the grid belonging to the object surface or from the grid belonging to the outside of the object.

FIG. 2 is an explanatory diagram for explaining an example of the odds according to the embodiment. In the example illustrated in FIG. 2, in a space 101 of grids that are identified from the space information, a three-dimensional point 102 (three-dimensional coordinate \tilde{x}) having three-dimensional shape data is included in a grid g1. In that case, in the space 101 of grids, the updating unit 13 defines a half line 105 that extends to infinity in the direction which starts from a position V1 of the observing unit 11 generated by the generating unit 12 (hereinafter, simply referred to as “position V1”) and which passes through the three-dimensional point 102. Then, the updating unit 13 makes use of Expression (2) to obtain the probability of having the true three-dimensional coordinate x within a grid g2 (for example, a grid 106) that includes the half line 105; and makes use of Expression (3) to obtain the likelihood of having the true three-dimensional coordinate x within the grid g2. Thus, the likelihood serves as the probability or the odds of the presence of the target object for measurement in the grid g2.

$$\begin{matrix}P ( \tilde{x} , g 2 ) = Pr ( x ∈ g 2 \vert \tilde{x} ∈ g 1 ) & ( 2 ) \\ log \frac{P ( \tilde{x} , g 2 )}{( 1 - P ( \tilde{x} , g 2 ) )} & ( 3 )\end{matrix}$$

Meanwhile, if the position of the observing unit 11 generated by the generating unit 12 is provided, if the three-dimensional point (the coordinates included in the three-dimensional shape data) is provided, if the error model is provided, and if the grid for which the odds are to be known is provided; then Expression (2) can be calculated by means of probability calculation based on, for example, the theoretical concept of occupancy map.

Given below is the explanation of a method of updating the space information (containing the odds, the observation flag, and the outline flag) implemented by the updating unit 13.

If the observing unit 11 has performed the observation for the first time, then the updating unit 13 initializes the space information prior to updating it. While initializing the space information, the updating unit 13 sets the center of each of the division areas, which are three-dimensional grid-like areas of a predetermined size obtained by uniformly dividing the three-dimensional space in the world coordinate system, to the position of the center of gravity of the three-dimensional shape data; sets the size of the division areas and the number of divisions of the three-dimensional grid to predetermined values; and defines grids in the space information. For example, the updating unit 13 sets the size of a division area to a cube in which the length of the sides is twice the distance from the position of the observing unit 11 generated by the generating unit 12 to the position of the center of gravity of the three-dimensional shape data. Then, for each grid in the space information; the updating unit 13 initializes the odds to “0”, initializes the observation flag to “0”, and initializes the external flag to “1”.

Regarding the odds, the updating unit 13 refers to the position of the observing unit 11 generated by the generating unit 12 and to each three-dimensional point include in the three-dimensional shape data, and calculates latest odds o^{new} for each grid in the space information. Then, for each grid, the updating unit 13 compares the latest odds o^{new} with past odds o^{old}. If the latest odds o^{new} are greater than the past odds o^{old}, then the updating unit updates the past odds o^{old} to the latest odds o^{new}. Herein, the updating unit can update the past odds o^{old} to the latest odds o^{new} by referring to the algorithm disclosed in the literature “Improved Occupancy Grids for Map Building” by Konolige, K. (1997) in Autonomous Robots, vol. 4, 351-367 and on the basis theoretical concept of occupancy map.

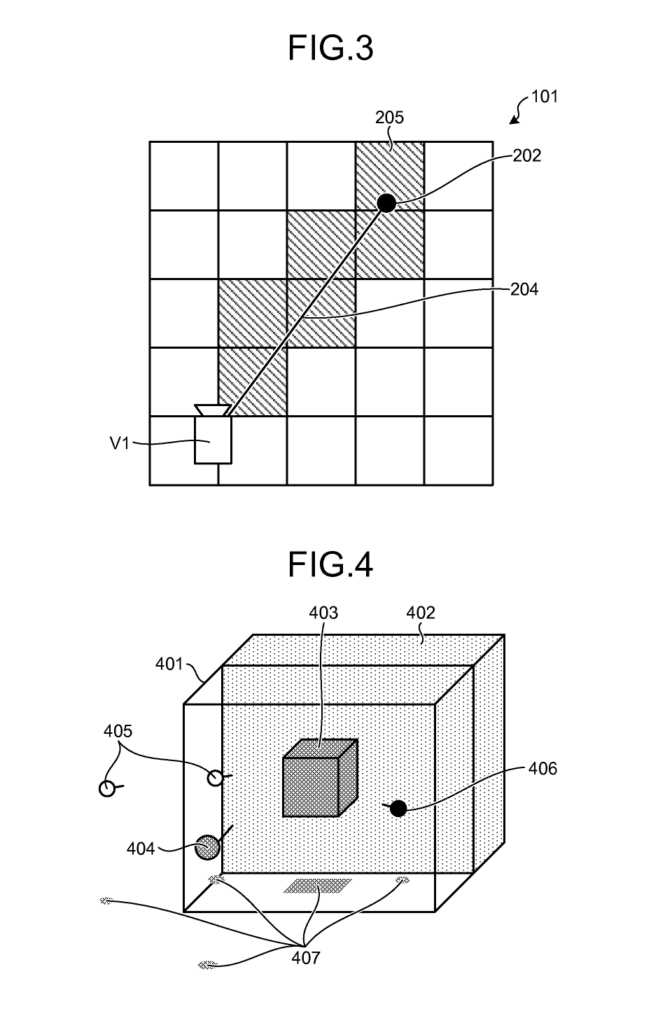

Regarding the updating of the observation flag, the explanation is given with reference to FIG. 3. Herein, FIG. 3 is an explanatory diagram for explaining an exemplary method of updating the observation flag according to the embodiment. In the example illustrated in FIG. 3, in the space 101 of grids identified from the space information, the updating unit 13 defines a line segment 204 from a three-dimensional point 202(x) to the position V1. The updating unit 13 can extend the end point (the three-dimensional point 202) of the line segment 204 by a predetermined length in the direction from the position V1 toward the three-dimensional point 202. Then, regarding each grid 205 that includes the line segment 204; if the absolute value of the odds is greater than a predetermined value, then the updating unit 13 sets the observation flag to “1”. In contrast, regarding each grid 205 that includes the line segment 204; if the absolute value of the odds is equal to or smaller than the predetermined value, then the updating unit 13 sets the observation flag to “0”.

Regarding the external flags; the updating unit 13 sets all such grids in the space information which have “0” in the respective observation flags as empty spaces; sets all such grids in the space information which have “1” in the respective observation flags as walls; and implements the Flood Fill algorithm to search for an enclosed space to which belong all grids having “0” in the respective observation flags. Then, until the search is completed, if any grid serving as the boundary surface of the enclosed space and having “0” in the observation flag is present, then the updating unit 13 sets “1” in the external flags of the grids that belong to the enclosed section obtained after the completion of the search. On the other hand, until the search is completed, if there is no grid serving as the boundary surface of the enclosed space and having “0” in the observation flag as well as if the position of the observing unit 11 is not included in the enclosed section, then the updating unit 13 sets “0” in the external flags of the grids that belong to the enclosed section obtained after the completion of the search. Meanwhile, the updating unit 13 can update the external flags by implementing a method other than the Flood Fill algorithm.

The determining unit 14 refers to the space information updated by the updating unit 13 and determines whether or not the three-dimensional measurement is completed. That is, the determining unit 14 determines whether or not the observing unit 11 has completed performing observation.

For example, the determining unit 14 makes use of Expression (4) to obtain a measurement rate γ1, makes use of Expression (5) to obtain a precision achievement rate γ2, and makes use of Expression (6) to obtain an average achieved precision γ3.

$$\begin{matrix}γ 1 = {\sum }_{g ∈ G 2} {f}_{observed} ( g ) / \vert G 1 \vert & ( 4 ) \\ γ 2 = {\sum }_{g ∈ G 2} ( {f}_{odds} ( g ) > β ) / \vert G 2 \vert & ( 5 ) \\ γ 3 = {\sum }_{g ∈ G 2} {f}_{odds} ( g ) / \vert G 2 \vert & ( 6 )\end{matrix}$$

Herein, “G1” represents a group of grids having “1” set in the respective external flags included in the space information; “G2” represents a group of grids that are included in the group G1 and that have “1” set in the respective observation flags; and |A| represents the number of elements included in a group A. Moreover, f_{observed}( ) is a function that returns the value of the observation flag of a grid; and f_{odds}( ) is a function that returns the odds of a grid.

Thus, the measurement rate γ1 is the number obtained by dividing, by |G1|, the sum of the observation flags of all grids included in the group G1. The precision achievement rate γ2 is the number obtained by dividing, by |G2|, the number of such grids included in the group G2 which have the respective odds greater than a predetermined value β. The average achieved precision γ3 is the number obtained by dividing, by |G2|, the sum of odds of all grids included in the group G2.

Then, the determining unit 14 makes use of, for example, Expression (7) and determines whether or not the three-dimensional measurement is completed.

(γ1>α1)∩(γ2>α2)∩(γ3>α3) (7)

That is, the determining unit 14 determines that the three-dimensional measurement is completed if any one of the following conditions is satisfied: the measurement rate γ1 is greater than a predetermined value α1; the precision achievement rate γ2 is greater than a predetermined value α2; and the average achieved precision γ3 is greater than a predetermined value α3.

The instructing unit 15 instructs an area setting method for setting a search area in which candidates for the next position of the observing unit 11 and candidates for the next orientation of the observing unit 11 are to be searched. For example, the instructing unit 15 instructs an area setting method in which all areas in the space indicated by the space information are set as search areas. However, that is not the only possible area setting method. Alternatively, it is possible to have a combination of an area setting method in which the observed areas in the space indicated by the space information are set as search areas and an area setting method in which the areas present within a predetermined scope from the position of the observing unit 11 generated by the generating unit 12 are set as search areas.

The calculating unit 16 calculates the next position and the next orientation of the observing unit 11 by referring to the position and the orientation of the observing unit 11 generated by the generating unit 12; the error model generated by the generating unit 12; the space information updated by the updating unit 13; and the area setting method instructed by the instructing unit 15. However, the calculation is possible even if the space information is not updated by the updating unit 13.

The calculating unit 16 sets, with respect to the space indicated by the space information that is updated by the updating unit 13, search areas by implementing the area setting method instructed by the instructing unit 15; calculates a measurement quality increment of the position (as an example, a second position) and the orientation (as an example, a second orientation) for each grid in the search areas that are set; and sets such a position (as an example, a third position) and such an orientation (as an example, a third orientation) at which the calculated measurement quality increment satisfies predetermined conditions as the new position and the new orientation of the observing unit 11. Herein, the measurement quality increment is an expected value of measurement quality with respect to the target object for measurement, and represents the reduction in the unmeasured area (i.e., the increment in the measured area) or the increment in measurement precision. Meanwhile, the position of a grid in a search area points to, for example, the gravity point of that grid; and the orientation of a grid in a search area points to, for example, all combinations obtained by allowing overlapping of angles, which are divided into a predetermined number of divisions between 0° and 360°, onto the angles of the X axis, the Y axis, and the Z axis.

More particularly, firstly, the calculating unit 16 places the error model of the observing unit 11 generated by the generating unit 12 on the positions and the orientations in the search areas.

Then, regarding each grid g included in the group G1 that is mentioned in the explanation of the determining unit 14, the calculating unit 16 sets the position V1, which is mentioned in the explanation of the updating unit 13, as the position of the observing unit 11; sets the three-dimensional coordinate \tilde{x}, which is mentioned in the explanation of the updating unit 13, as the coordinate of the center of gravity of each grid g included in the group G1; and sets the grid g2, which is mentioned in the explanation of the updating unit 13, as each grid g included in the group G1. Subsequently, with the use of Expression (3), the calculating unit 16 obtains the odds o^{new} for each grid g included in the group G1 of the target object for measurement. Meanwhile, each grid g included in the group G1 has the past odds of o^{old}.

In Expression (8) given below, a function f_{surface}( ) takes the odds as the argument. If the odds are greater than a predetermined value γ (desirably a positive value), then the function f_{surface}( ) returns “1”. In contrast, if the odds are equal to or smaller than the predetermined value γ, then the function f_{surface}( ) returns “0”. When the function f_{surface}( ) returns “1”, the odds taken as the argument indicate that the grid is a space in which an object is present. In contrast, when the function f_{surface}( ) returns “0”, the odds taken as the argument indicate that the grid is a space in which no object is present.

$${f}_{surface} ( Odds ) = \{ \begin{matrix}1 & if Odds > γ \\ 0 & else\end{matrix} \qquad ( 8 )$$

Subsequently, when the target object for measurement is observed using the position and the orientation in a search area, the calculating unit 16 calculates a cubic volume C₁ of the newly measurable area by making use of Expressions (9) and (8). In essence, the cubic volume C₁ of the newly measurable area is equivalent to the percentage of unobserved area within the space indicated by the space information. Moreover, the cubic volume C₁ of the newly measurable area is equivalent to the percentage that is based on whether or not, of the grids within the space indicated by the space information, the grids on the outside of the target object for measurement have already been measured.

C₁=|{gεG1|f_{observed}(g)=0∩f_{surface}(o^{new})=1}| (9)

Moreover, with respect to the grid g belonging to the group G1 in which the object that is already observed using Expression (8) is determined to be present (more specifically, with respect to the grid for which f_{surface}(o^{old})=1 is satisfied), when the target object for measurement is measured using the position and the orientation in a search area, the calculating unit 16 makes use of Expressions (10) and (8) and calculates C₂ that indicates the degree of improvement in the measurement precision. Herein, C₂ indicating the degree of improvement in the measurement precision is a value based on the probability of the presence of objects in the grids that are on the outside of the target object for measurement from among the grids within the space indicated by the space information.

$${C}_{2} = {\sum }_{g ∈ G 1 ⋂ {f}_{surface} ( {o}^{old} ) = 1} ( {f}_{surface} ( {o}^{new} ) = 1 ) * ( {o}^{new} - {o}^{old} ) \qquad ( 10 )$$

Lastly, using Expression (11), the calculating unit 16 calculates a measurement quality increment I of the position and the orientation in the search area.

I=α₆₁*C₁+α₆₂*C₂ (11)

Herein, α₆₁ and α₆₂ are predetermined values.

Once the measurement quality increments regarding all grids in the search area are calculated, the calculating unit 16 sets the positions and the orientations in descending order of the measurement quality increments and, for example, sets the position and the orientation corresponding to the largest measurement quality increment as the new position and the new orientation of the observing unit 11.

Meanwhile, the calculating unit 16 need not calculate the measure quality increments for all combinations of positions and orientations in the search areas. Instead, the calculating unit 16 can select a subgroup of an appropriate combination and set it as the new position and the new orientation in the search area. Moreover, in a measurement quality increment, the calculating unit 16 either can take into account the distance between the position of the observing unit 11 generated by the generating unit 12 and the position of the search area or can take into account the size of the difference between the orientation of the observing unit 11 generated by the generating unit 12 and the orientation of the search area.

The display control unit 17 displays, on the display unit 18, the space information that is updated by the updating unit 13 as well as displays at least either one of the new position and the new orientation of the observing unit 11 that are calculated by the calculating unit 16. The display unit 18 displays various screens and can be implemented using a display device such as a liquid crystal display or a touch-sensitive panel display.

FIG. 4 is a diagram illustrating an example of a display according to the embodiment. In FIG. 4 is illustrated a display screen that displays the space, which is indicated by the space information updated by the updating unit 13, as well as displays the position and the orientation calculated by the calculating unit 16.

In the example illustrated in FIG. 4, the space that is indicated by the space information updated by the updating unit 13 is drawn in a computer graphics (CG) space. Herein, a grid 401 represents the boundary of the area. An unobserved area 402 points to the area in which a grid having the observation flag set to “0” is drawn in a predetermined color. An already-observed area 403 points to the area in which a grid having the observation flag set to “1” and having the odds greater than a predetermined value is drawn in a predetermined color that is different than the color of the unobserved area 402. Meanwhile, the hollow area within the boundary of the grid 401 is a grid having the observation flag set to “1” and having the odds equal to or smaller than a predetermined value, and is determined not to have any object therein.

Moreover, in the example illustrated in FIG. 4, the position and the orientation are also drawn in the CG space. The coordinates of the position are expressed using a spherical object of a predetermined size, and the orientation is expressed using a line having a predetermined length. Herein, in a position-and-orientation set 404, the current position and the current orientation of the observing unit 11 (i.e., the position and the orientation of the observing unit 11 generated by the generating unit 12) are expressed in a predetermined color. In contrast, in position-and-orientation sets 405, past positions and past orientations of the observing unit 11 are expressed in a predetermined color. Moreover, in a position-and-orientation set 406, the next position and the next orientation of the observing unit 11 (i.e., the position and the orientation calculated by the calculating unit 16) are expressed in a predetermined color. Meanwhile, the position-and-orientation sets 404 to 406 can be displayed in the same color or in different colors.

In FIG. 4, shadows 407 include the shadow of the already-observed area 403 and the shadows of the position-and-orientation sets 404 to 406 that are formed with respect to a predetermined light source and that fall on a plane in which lies a predetermined surface of the boundary of the grid 401. The shadows 407 are formed so as to facilitate intuitive understanding of the positional relationships between the already-observed area 403 and the position-and-orientation sets 404 to 406.

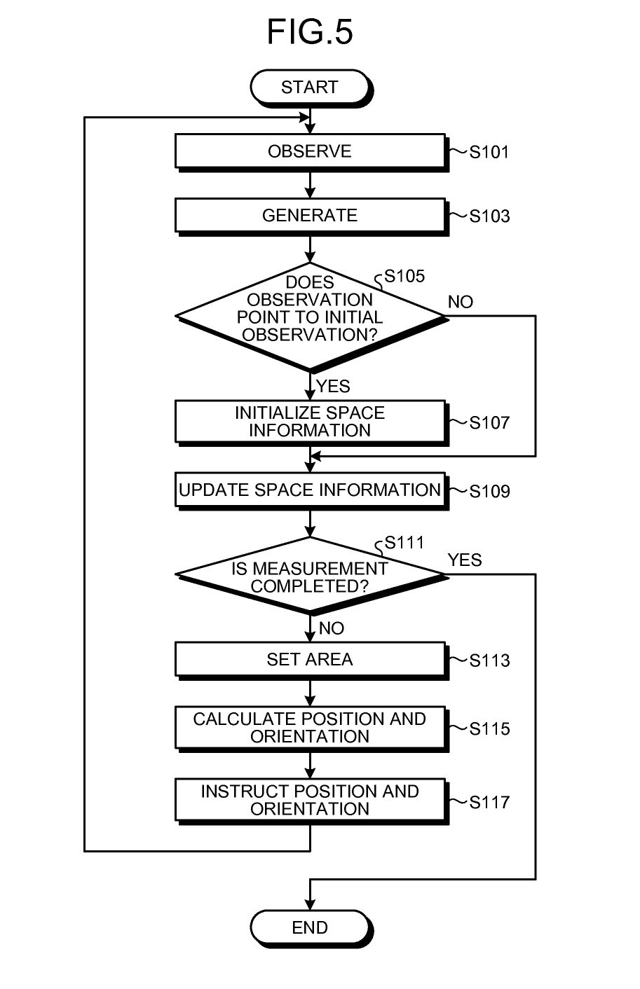

FIG. 5 is a flowchart for explaining an exemplary sequence of operations performed in the measuring device 10 according to the embodiment.

Firstly, the observing unit 11 obtains observation data by observing the space that contains the target object for measurement (Step S101).

Then, the generating unit 12 generates the position and the orientation of the observing unit 11; generates three-dimensional shape data of the target object for measurement on the basis of the observation data; and generates an error model of the observing unit 11 (Step S103).

Subsequently, the updating unit 13 confirms whether or not the observing unit 11 has performed the initial observation, that is, whether or not the observing unit 11 has performed the observation for the first time (Step S105). If the observation is the initial observation (Yes at Step S105), the updating unit 13 initializes space information (Step S107). On the other hand, if the observation is not the initial observation (No at Step S105); then the operation at Step S107 is not performed.

Then, the updating unit 13 refers to the position of the observing unit 11 generated by the generating unit 12, the orientation of the observing unit 11 generated by the generating unit 12, the error model generated by the generating unit 12, and the three-dimensional shape data of the target object for measurement; and updates the space information (Step S109).

Subsequently, the determining unit 14 refers to the space information that is updated by the updating unit 13 and determines whether or not the three-dimensional measurement is completed, that is, determines whether or not the observing unit 11 has completed performing observation (Step S111). If the three-dimensional measurement is completed (Yes at Step S111), the operations are terminated.

On the other hand, if the three-dimensional measurement is not yet completed (No at Step S111), then the instructing unit 15 instructs an area setting method for setting a search area in which candidates for the next position of the observing unit 11 and candidates for the next orientation of the observing unit 11 are to be searched (Step S113).

Then, the calculating unit 16 calculates the next position and the next orientation of the observing unit 11 by referring to the position of the observing unit 11 generated by the generating unit 12; the orientation of the observing unit 11 generated by the generating unit 12; the error model generated by the generating unit 12; the space information updated by the updating unit 13; and the area setting method instructed by the instructing unit 15 (Step S115).

Subsequently, on the display unit 18, the display control unit 17 displays the space information that is updated by the updating unit 13 and displays the next position and the next orientation of the observing unit 11 that are calculated by the calculating unit 16 (Step S117).

Then, the system control returns to Step S101, and the observing unit 11 observes the space, which contains the target object for measurement, using the position and the orientation calculated by the calculating unit 16.

With reference to the flowchart illustrated in FIG. 5, the explanation is given for an example in which the space information is initialized after the observing unit 11 performs the initial observation and after the generating unit 12 generates the position and the orientation. However, the initialization of the space information is not limited to that timing. Alternatively, the initialization of the space information can be performed before the observing unit 11 performs the initial observation.

In this way, according to the embodiment, using the error model of the observing unit 11 and the probability of the presence of objects in the space containing the target object for measurement; the reduction in the unmeasured area or the increment in measurement precision is calculated for the positions and the orientations in search areas, and such a position and such an orientation are selected that make it possible to enhance the measurement precision while reducing the portion to be measured. Hence, according to the embodiment, even in the case of performing three-dimensional measurement of a target object for measurement having an unknown shape, it becomes possible to enhance the measurement precision while reducing the portion to be measured. As a result, it becomes possible to generate highly accurate three-dimensional data having no defects.

Hardware Configuration

Given below is the explanation of an exemplary hardware configuration of the measuring device 10 according to the embodiment. The measuring device 10 according to the embodiment has a hardware configuration of a commonplace computer that includes a control device such as a CPU; a memory device such as a read only memory (ROM) or a random access memory (RAM); an external memory device such as a hard disk drive (HDD); a display device such as a display; an input device such as a keyboard or a mouse; and a communication device such as a communication interface.

The computer programs that are executed in the measuring device 10 according to the embodiment described above are stored in the form of installable or executable files in a computer-readable storage medium such as a compact disk read only memory (CD-ROM), a compact disk readable (CD-R), a memory card, a digital versatile disk (DVD), or a flexible disk (FD), as a computer program product.

Alternatively, the computer programs that are executed in the measuring device 10 according to the embodiment described above can be saved as downloadable files on a computer connected to the Internet or can be made available for distribution through a network such as the Internet. Still alternatively, the computer programs that are executed in the measuring device 10 according to the embodiment described above can be distributed over a network such as the Internet. Still alternatively, the computer programs that are executed in the measuring device 10 according to the embodiment described above can be stored in advance in a ROM or the like.

Meanwhile, the computer programs that are executed in the measuring device 10 according to the embodiment described above contain a module for each of the above-mentioned constituent elements to be implemented in a computer. In practice, for example, a CPU reads a program from an HDD and runs it such that the computer programs are loaded in the RAM. As a result, the module for each of the above-mentioned constituent elements is generated in the computer.

As described above, according to the embodiment, it becomes possible to enhance the measurement precision while reducing the portion to be measured of a target object for measurement.

The steps of the flowchart in the embodiment and modifications may be performed in a different order on the embodiment or some of the steps may be performed in parallel.

While certain embodiments have been described, these embodiments have been presented by way of example only, and are not intended to limit the scope of the inventions. Indeed, the novel embodiment described herein may be embodied in a variety of other forms; furthermore, various omissions, substitutions and changes in the form of the embodiment described herein may be made without departing from the spirit of the inventions. The accompanying claims and their equivalents are intended to cover such forms or modifications as would fall within the scope and spirit of the inventions.

What is claimed is:

1. A measuring device comprising:
a generating unit configured to generate a first position of an observing unit for observing a space containing a target object, a first orientation of the observing unit, an error model indicating a theoretical precision of observation performed by the observing unit, and three-dimensional shape data of the target object that has been observed by the observing unit;
an updating unit configured to update space information that indicates a probability of the presence of the target object at each coordinate within the space, using the first position and the three-dimensional shape data; and
a calculating unit configured to
calculate a measurement quality increment for a second position and a second orientation of a search area within the space using the error model and the space information, and
set a third position and a third orientation for which the calculated measurement quality increment satisfies a predetermined condition as a new position and a new orientation of the observing unit, respectively.

2. The device according to claim 1, wherein
the space information further indicates whether the observing unit has already observed each coordinate in the space, and
the calculating unit calculates an observation precision that is based on the error model and the probability of the presence of the target object indicated by the space information, calculates a percentage of an unobserved area within the space on the basis of the space information indicating whether the observing unit has already observed each coordinate in the space, and calculates the measurement quality increment by combining the observation precision with the percentage at a predetermined rate.

3. The device according to claim 2, wherein
the space information further indicates whether each coordinate within the space is on the outside of the target object, and
the calculating unit calculates the observation precision on the basis of the probability of the presence of the target object at a coordinate on the outside of the object from among the coordinates within the space, and calculates the percentage on the basis of whether the coordinate on the outside of the object from among the coordinates within the space have already been observed.

4. The device according to claim 1, further comprising a determining unit configured to determine whether observation is completed, using the space information.

5. The device according to claim 1, wherein the calculating unit uses either a distance between the first position and the second position or a difference between the first orientation and the second orientation to calculate the measurement quality increment.

6. The device according to claim 1, wherein the third position and the third orientation are the second position and the second orientation corresponding to the largest measurement quality increment that is calculated.

7. The device according to claim 1, wherein
the space is divided into exclusive areas, and
each coordinate within the space is for the representative point of one of the areas.

8. The device according to claim 1, further comprising a display control unit configured to display the space indicated by the space information and at least one of the third position and the third orientation on a display unit.

9. A measuring method comprising:
generating a first position of an observing unit for observing a space containing a target object, a first orientation of the observing unit, an error model indicating a theoretical precision of observation performed by the observing unit, and three-dimensional shape data of the target object that has been observed by the observing unit;
updating space information that indicates a probability of the presence of the target object at each coordinate within the space, using the first position and the three-dimensional shape data;
calculating a measurement quality increment for a second position and a second orientation of a search area within the space using the error model and to the space information; and
setting a third position and a third orientation for which the calculated measurement quality increment satisfies a predetermined condition as a new position and a new orientation of the observing unit, respectively.

10. A computer program product comprising a computer-readable medium containing a program executed by a computer, the program causing the computer to execute:
generating a first position of an observing unit for observing a space containing a target object, a first orientation of the observing unit, an error model indicating a theoretical precision of observation performed by the observing unit, and three-dimensional shape data of the target object that has been observed by the observing unit;
updating space information that indicates a probability of the presence of the target object at each coordinate within the space, using the first position and the three-dimensional shape data;
calculating a measurement quality increment for a second position and a second orientation of a search area within the space using the error model and to the space information; and
setting a third position and a third orientation for which the calculated measurement quality increment satisfies a predetermined condition as a new position and a new orientation of the observing unit, respectively.
